(19) United States
(12) Patent Application Publication
(10) Pub. No.: US 2025/0158860 A1
(43) Pub. Date: May 15, 2025

(54) ALIGNMENT DETECTION CIRCUITRY

(71) Applicant: XILINX, INC., San Jose, CA (US)

(72) Inventor: Martin RIIS, Edinburgh (GB)

(21) Appl. No.: 18/509,394

(22) Filed: Nov. 15, 2023

(51) Int. Cl. H04L 27/26

(52) U.S. Cl. CPC H04L 27/26025

(57) ABSTRACT

Examples herein describe alignment detection circuitry. The alignment detection circuitry includes a buffer, a first set of correlators, and a second set of correlators. The buffer is configured to output a data stream of multiplexed groups of symbols from multiple data lanes. The first set of correlators is configured to search a candidate data lane of the data stream for bits matching bits of a reference alignment marker based on a first search method. The second set of correlators is configured to search the candidate data lane of the data stream for bits matching the bits of the reference alignment marker based on a second search method.

### TECHNICAL FIELD

Examples of the present disclosure generally relate to wired communication systems (e.g., optical, electric, etc.), and more specifically, to alignment detection circuitry.

### BACKGROUND

Wired communication systems transmit data from parallel data lanes (separate communication channels) over a physical interface (e.g., electrical or optical) by multiplexing the data lanes onto the physical interface. The parallel data lanes are multiplexed into a series by a transmitter which also inserts alignment markers at regular intervals within the series. These alignment markers are predefined bit patterns which are detected by a receiver to indicate where data from a particular data lane begins in the series. After detecting the alignment markers, the receiver is capable of de-multiplexing the series to recover the data from each of the parallel data lanes.

However, efficiently detecting the alignment markers and recovering/realigning the data lanes is challenging because of timing misalignments or “skew” that can occur with respect to the series and within individual data lanes. For example, it is unlikely that the receiver begins searching for the alignment markers at a beginning bit of the series. As a result, if the transmitter inserts the alignment markers spaced a particular number of bits apart in the series, then it is likely that the receiver will first encounter an alignment marker before searching the particular number of bits in the series. Additionally, relative propagation delays between the data lanes (the communication channels) due to different lengths of the channels and/or different characteristics of the channels can also introduce skew. Because of the skew, many different correlation operations must be performed in order to detect the alignment markers which increases computational costs (power consumption) and/or delays recovery of the data lanes.

### SUMMARY

Alignment detection circuitry is described in some embodiments. In one or more embodiments, the alignment detection circuitry includes a buffer, a first set of correlators, and a second set of correlators. For instance, the buffer is configured to output a data stream of multiplexed groups of symbols from multiple data lanes. In some examples, the first set of correlators may be configured to search a candidate data lane of the data stream for bits matching bits of a reference alignment marker based on a first search method. The second set of correlators can be configured to search the candidate data lane of the data stream for bits matching the bits of the reference alignment marker based on a second search method.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates correlator circuitry, according to an example.

FIG. 2 illustrates an example of symbol-pair multiplexing, according to an example.

FIGS. 3A, 3B, and 3C illustrate an example of a timing misalignment relative to a physical interface, according to an example.

FIG. 4 illustrates receiver circuitry, according to an example.

FIGS. 5A, 5B, 5C, and 5D illustrate an example of a timing misalignment relative to a physical interface and a timing misalignment relative to a data lane, according to an example.

FIG. 6 is a flow diagram depicting a method for alignment marker detection.

### DETAILED DESCRIPTION

Efficiently detecting alignment markers by a receiver of a wired communications system and recovering/realigning data lanes multiplexed into a series by a transmitter of the communications system is challenging because of skew (timing misalignments) that can occur with respect to the series and within individual data lanes. Since this skew could be anywhere, many different correlation operations are performed by the receiver in order to detect the alignment markers. However, performing many correlation operations consumes computational resources and/or delays recovery of the data lanes.

Examples herein describe alignment detection circuitry including two shifter circuitry stages and first and second correlator circuits which operate in parallel to efficiently detect alignment markers and recover data lanes in wired communications systems using multiplexed groups of symbols. In some embodiments, a data stream of multiplexed groups of symbols (e.g., symbol-pairs or symbol-quartets) is received via a physical link (e.g., an electrical or optical interface). In an example, the first and second correlator circuits each include a same number of correlators as a number of bits included in the groups of symbols.

In various embodiments, bit skew is added to a candidate data lane included in the data stream such that all possible skew scenarios can be evaluated for the candidate data lane. For example, if the groups of symbols include symbol-pairs and each symbol is 10 bits in length, then bit skew is added to the candidate data lane between 0 to 19 bits. In this example, the first and second correlator circuits each include 20 correlators to check all of the possible skew scenarios (e.g., 20 different start points for de-multiplexing).

The first and second correlator circuits each search the candidate data lane of the data stream in parallel for bits that match bits of a reference alignment marker. Notably, in the IEEE 802.3dj standard, odd numbered data lanes include a 10 bit offset and even numbered data lanes do not include the 10 bit offset. Since the candidate data lane may be even numbered or odd numbered, the first correlator circuit searches the candidate data lane without the 10 bit offset (assuming an even number) and the second correlator circuit searches the candidate data lane with the 10 bit offset (assuming an odd number).

In some embodiments, the first and second correlator circuits do not search the candidate data lane of the data stream for bits matching all of the bits of the reference alignment marker. For example, the reference alignment marker is 12 nibbles in length, and the first and second correlator circuits search the candidate data lane for bits that match a subset of the 12 nibbles (e.g., a first 9 nibbles of the 12 nibbles). In various embodiments, the first and second correlator circuits are each capable of outputting an indication of a complete match of the subset of the 12 nibbles or a partial match of the subset.

In one or more embodiments, a shift selection circuit of the alignment detection circuitry receives the outputs from the first correlator circuit and the second correlator circuit. In some examples, the shift selection circuit determines whether to use skew information (e.g., based on identified matches with the reference alignment marker) from the first correlator circuit or from the second correlator circuit based on the outputs. For instance, bit skew and lane skew are removed based on the skew information in order to recover data lanes from the data stream.

The use of the first and second independent correlator circuits in parallel facilitates locking of the data lanes quickly by identifying two consecutive alignment markers compared to a single correlator circuit which would require identification of four consecutive alignment markers in order to lock the data lanes (for the first two alignment markers, all data lanes are assumed to be even; for the second two alignment markers, all data lanes are assumed to be odd). Additionally, by searching the candidate data lanes for bits that match the subset of the bits of the reference alignment marker, the alignment detection circuitry minimizes a total number of correlation operations performed in order to recover the data lanes. Minimizing the number of correlation operations performed reduces the consumption of computational resources and/or increases a speed at which the data lanes can be recovered.

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

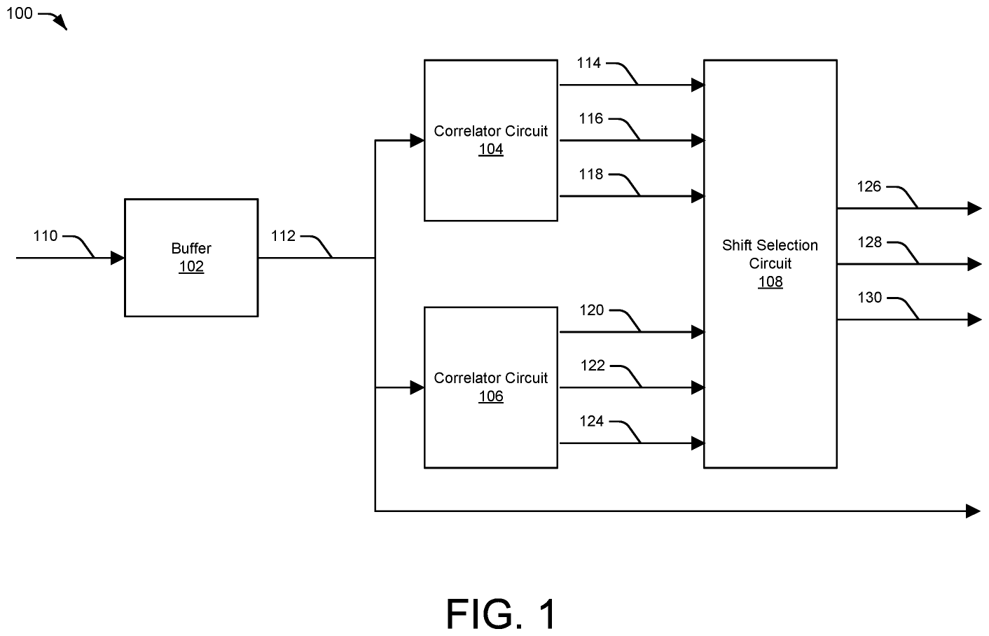

FIG. 1 illustrates correlator circuitry 100, according to an example. In various embodiments, the correlator circuitry 100 is part of an electrical or optical communications system that includes multiple data lanes (e.g., separate communication channels) to be simultaneously transmitted over a physical interface. For instance, the data lanes are multiplexed into a data series by a transmitter of the communications system. The transmitter also inserts alignment markers within the data series at regular intervals. These alignment markers are predefined bit patterns which are detectable by a receiver of the communications system to indicate where data from a particular data lane begins in the data series. The alignment markers are inserted into the data series because some of the data lanes can have time delays or “skew” relative to other data lanes. By detecting the alignment markers, the receiver is capable of identifying and correcting the time delays and de-multiplexing the data series in order to recover/realign the data lanes.

In some embodiments, the correlator circuitry 100 is part of a communications system which complies with a portion of a standard such as IEEE 802.3dj. The IEEE 802.3dj standard defines parameters for mapping 25 gigabits per second (Gbps) data lanes onto a physical interface using symbol multiplexing. As used herein, the term “symbol” refers to a group of bits. For example, in the IEEE 802.3 standard, a symbol has a length of 10 bits.

The IEEE 802.3dj standard provides support for multiplexing eight 25 Gbps data lanes onto a single 200 Gbps physical link and for multiplexing two 100 Gbps data lanes onto a single 200 Gbps physical link. For instance, the IEEE 802.3dj standard also introduces two methods of multiplexing the data lanes onto the physical link which are symbol-pair multiplexing and symbol-quartet multiplexing. It is to be appreciated that systems and techniques described herein in relation to symbol-pair multiplexing are equally applicable to symbol-quartet multiplexing and other symbol multiplexing (except where differences between implementations of symbol-pair multiplexing and symbol-quartet multiplexing are described). For example, the described systems and techniques can be implemented for multiplexing four 50 Gbps data lanes onto a single 200 Gbps data lane.

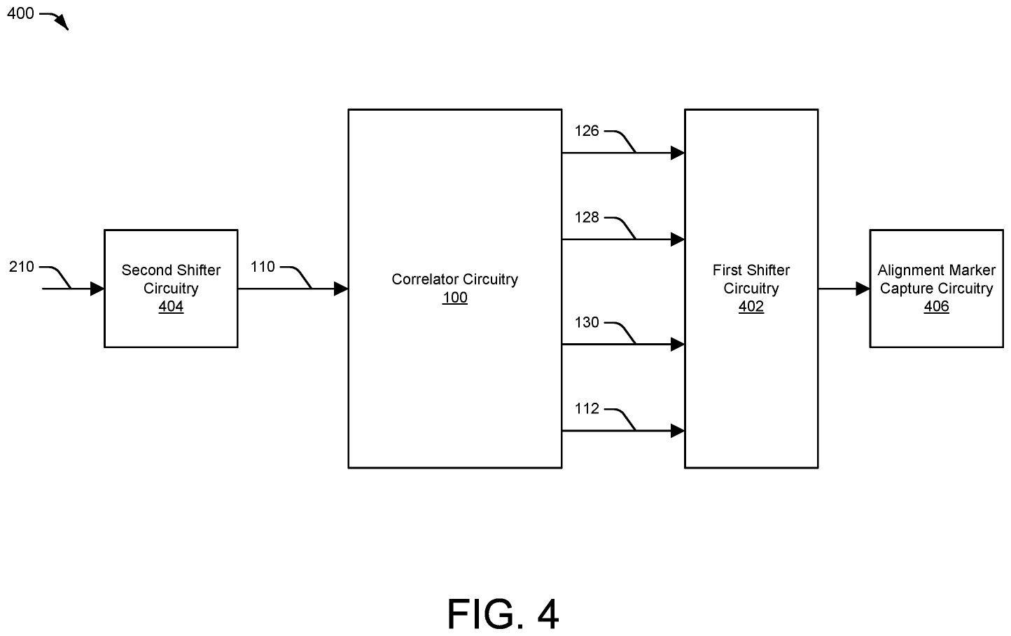

The correlator circuitry 100 is illustrated to include a buffer 102, a correlator circuit 104, a correlator circuit 106, and a shift selection circuit 108. In one or more embodiments, the buffer 102 receives an input 110 which may be received directly from a physical interface (e.g., the single 200 Gbps physical link). For example, the input 110 can be received from a serializer/deserializer (SERDES) circuit. In some embodiments, the buffer 102 receives the input 110 after an output from the physical interface has been processed at least partially as described with respect to FIG. 4 below.

The buffer 102 processes the input 110 to generate an output 112. In some examples, the output 112 is a data stream of multiplexed symbols (multiplexed groups of symbols) from multiple data lanes (e.g., the eight 25 Gbps data lanes). The groups of symbols can be symbol-pairs, symbol-quartets, symbol-octets, etc. In various embodiments, the buffer 102 generates the output 112 for processing by the correlator circuit 104 and the correlator circuit 106. The correlator circuits 104, 106 can be implemented using hardware (e.g., digital signal processors), software, or a combination of hardware and software. For example, the buffer 102 may buffer the input 110 into candidate data lanes in order to generate the output 112.

In an example in which the length of a symbol is 10 bits and the groups of symbols are symbol-pairs, then each group corresponds to a candidate data lane and there are 20 possible scenarios for skew. In this example, the skew can be between 0 and 19 bits (e.g., 20 bits of skew is equivalent to 0 bits). Continuing this example, the correlator circuit 104 can include 20 different correlators to check for each of the 20 possible scenarios for the skew. For example, the correlator circuit 104 evaluates 20 different starting points for de-multiplexing the output 112.

In another example in which the groups of symbols are symbol-quartets, then there are 40 possible scenarios for skew (e.g., the skew can be between 0 and 39 bits). Notably, in this other example, two 100 Gbps data lanes are multiplexed together and the odd numbered data lane is not delayed relative to the even numbered data lane. In this example, the correlator circuit 104 may include 20 different correlators to check for 20 of the 40 possible scenarios for the skew (e.g., the correlator circuit 104 detects skew between 0 and 19 bits), and the correlator circuit 106 may include 20 different correlators to check for 20 of the 40 possible scenarios for the skew (e.g., the correlator circuit 106 detects skew between 20 and 39 bits). Although examples in which the correlator circuits 104, 106 include 20 different correlators are described, it is to be appreciated that the correlator circuits 104, 106 can include less than 20 correlators or more than 20 correlators.

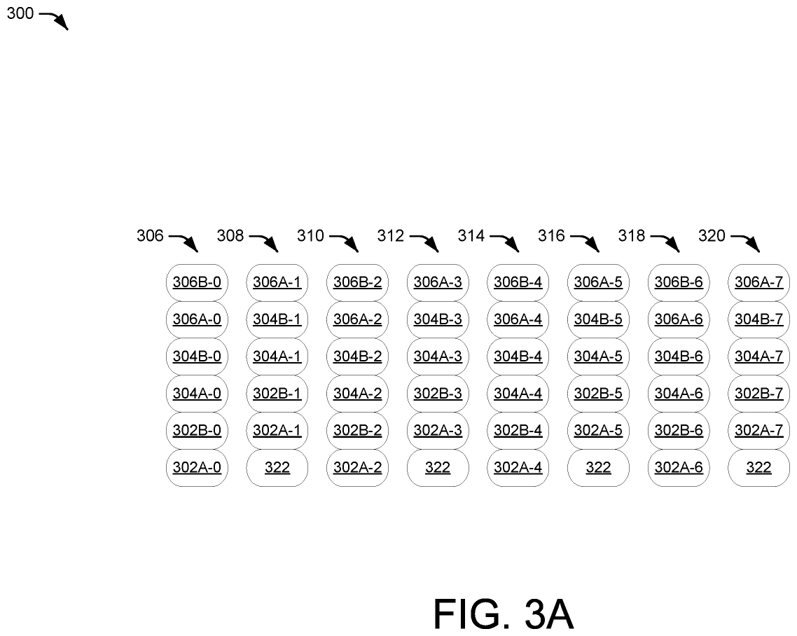

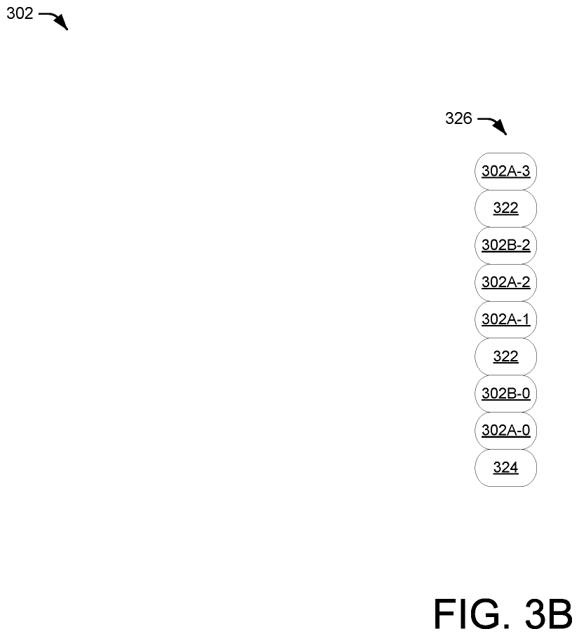

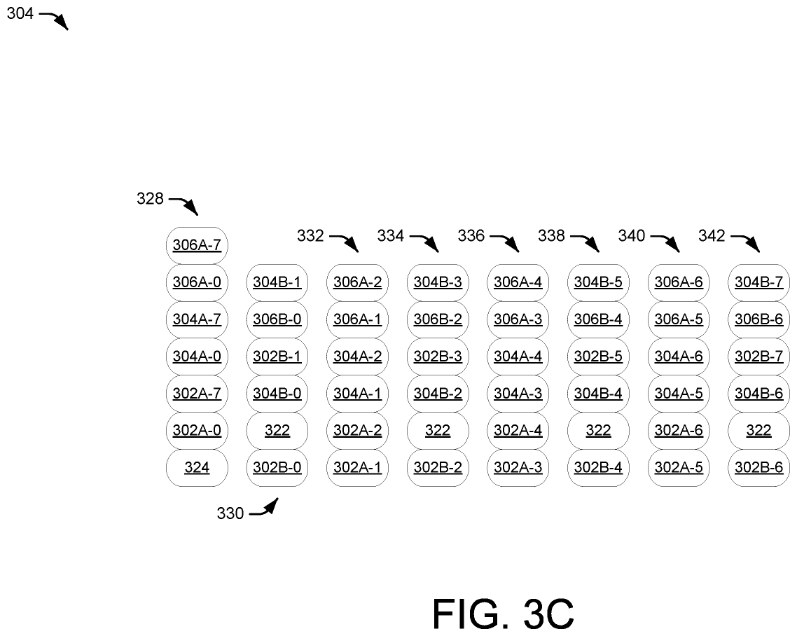

In some embodiments, the output 112 is a data stream of multiplexed groups of symbols from multiple data lanes, and some of these data lanes are offset (e.g., by an amount corresponding to one symbol). For instance, the IEEE 802.3dj standard includes an offset of 10 bits for odd numbered data lanes and no offset for even numbered data lanes which is illustrated in FIG. 3A. In various embodiments, data lanes of the output 112 which do not include an offset are de-multiplexed using a first de-multiplexing method (e.g., which does not account for the offset) and data lanes of the output 112 which include the offset are de-multiplexed using a second de-multiplexing method (e.g., which accounts for the offset).

In some examples, the correlator circuit 104 includes 20 different correlators that are configured to search a candidate data lane of the output 112 using a first search method (e.g., that does not include an offset). For example, the correlator circuit 106 includes 20 different correlators that are configured to search the candidate data lane of the output 112 using a second search method (e.g., that does include the offset). In one or more embodiments, the correlator circuit 104 searches the candidate data lane of the output 112 for bits matching bits of a reference alignment marker assuming that the candidate data lane is an even numbered data lane, and the correlator circuit 106 searches the candidate data lane of the output 112 (in parallel to the correlator circuit 104) for bits matching the bits of the reference alignment marker assuming that the candidate data lane is an odd numbered data lane.

In some embodiments, the correlator circuits 104, 106 search the candidate data lane of the output 112 for bits matching an entirety of the reference alignment marker (e.g., search for 48 bits that match a 48 bit reference alignment marker). In other embodiments, the correlator circuits 104, 106 search the candidate data lane of the output 112 for bits matching a subset of the bits of the reference alignment marker (e.g., search for 9 nibbles that match a first 9 nibbles of a 12 nibble reference alignment marker). Although examples are described relative to a 48 bit (12 nibble) reference alignment marker, it is to be appreciated that the described systems and techniques apply equally to examples of larger/smaller reference alignment markers and larger/smaller subsets of the reference alignment markers.

In various embodiments, the correlator circuit 104 includes 20 partial correlators configured to search the candidate data lane of the output 112 for nibbles matching a first 9 nibbles of a 12 nibble reference alignment marker. In these various embodiments, the correlator circuit 104 generates a matching output 114 if 9 nibbles of the candidate data lane of the output 112 match the first 9 nibbles of the reference alignment marker. In some examples, the correlator circuit 104 generates a partially matching output 116 if at least 6 nibbles of the candidate data lane of the output 112 match at least 6 of the first 9 nibbles of the reference alignment marker. In an example, the correlator circuit 104 generates a shift output 118 of 0 if less than 6 nibbles of the candidate data lane of the output 112 match nibbles of the first 9 nibbles of the reference alignment marker. In one or more embodiments, the correlator circuit 104 also generates the shift output 118 if the matching output 114 or the partially matching output 116 is generated in order to indicate a location of an alignment marker in the candidate data lane of the output 112.

Similarly, in some embodiments, the correlator circuit 106 includes 20 partial correlators configured to search the candidate data lane of the output 112 for nibbles matching the first 9 nibbles of the 12 nibble reference alignment marker. In various embodiments, the correlator circuit 106 generates a matching output 120 if 9 nibbles of the candidate data lane of the output 112 match the first 9 nibbles of the reference alignment marker. In one or more embodiments, the correlator circuit 106 generates a partially matching output 122 if at least 6 nibbles of the candidate data lane of the output 112 match at least 6 of the first 9 nibbles of the reference alignment marker. For example, the correlator circuit 106 generates a shift output 124 of 0 if less than 6 nibbles of the candidate data lane of the output 112 match nibbles of the first 9 nibbles of the reference alignment marker. In some examples, the correlator circuit 106 also generates the shift output 124 if the matching output 120 or the partially matching output 122 is generated in order to indicate a location of an alignment marker in the candidate data lane of the output 112.

As shown in the example depicted in FIG. 1, the shift selection circuit 108 receives the matching output 114, the partially matching output 116, and/or the shift output 118 from the correlator circuit 104 and the shift selection circuit 108 also receives the matching output 120, the partially matching output 122, and/or the shift output 124 from the correlator circuit 106. Since both of the correlator circuits 104, 106 are searching the same candidate data lane of the output 112 with different de-multiplexing methods, the shift selection circuit 108 determines whether to use skew information from the correlator circuit 104 (e.g., the shift output 118) or from the correlator circuit 106 (e.g., the shift output 124). The shift selection circuit 108 may be implemented using hardware, software, or a combination of hardware and software. For example, if the shift selection circuit 108 receives the matching output 114 from the correlator circuit 104 and if the shift selection circuit 108 also receives the matching output 120 from the correlator circuit 106, then the shift selection circuit 108 uses the skew information from whichever one of the correlator circuits 104, 106 has a lower shift value (e.g., in a corresponding one of the shift outputs 118, 124).

In some examples, if the shift selection circuit 108 receives the matching output 114 from the correlator circuit 104 and if the shift selection circuit 108 also receives the partially matching output 122 from the correlator circuit 106, then the shift selection circuit 108 uses the skew information from the correlator circuit 104 (e.g., the shift output 118). In various embodiments, if the shift selection circuit 108 receives the partially matching output 116 from the correlator circuit 104 and if the shift selection circuit 108 also receives the matching output 120 from the correlator circuit 106, then the shift selection circuit 108 uses the skew information from the correlator circuit 106 (e.g., the shift output 124). For example, if the shift selection circuit 108 receives the partially matching output 116 from the correlator circuit 104 and if the shift selection circuit 108 also receives the partially matching output 122 from the correlator circuit 106, then the shift selection circuit 108 uses the skew information from whichever one of the correlator circuits 104, 106 has a lower shift value (e.g., in a corresponding one of the shift outputs 118, 124).

In one or more embodiments, if the shift selection circuit 108 receives the partially matching output 116 from the correlator circuit 104 and if the shift selection circuit 108 does not receive the matching output 120 or the partially matching output 122 from the correlator circuit 106, then the shift selection circuit 108 uses the skew information from the correlator circuit 104 (e.g., the shift output 118). In some embodiments, if the shift selection circuit 108 does not receive the matching output 114 or the partially matching output 116 from the correlator circuit 104 and if the shift selection circuit 108 receives the partially matching output 122 from the correlator circuit 106, then the shift selection circuit 108 uses the skew information from the correlator circuit 106 (e.g., the shift output 124). Notably, if the shift selection circuit 108 receives at least one of the partially matching output 116 or the partially matching output 122, then a shift value should not be updated if the shift select circuit 108 received either the matching output 114 or the matching output 120 in a previous cycle. For instance, if the shift selection circuit 108 receives at least one of the partially matching output 116 or the partially matching output 122, then a shift value should not be updated if alignment marker capturing is in progress as this will result in an incorrect capture. As shown in FIG. 1, the shift selection circuit 108 outputs a matching output 126, a partially matching output 128, and/or a shift output 130 which is described further with respect to FIG. 4.

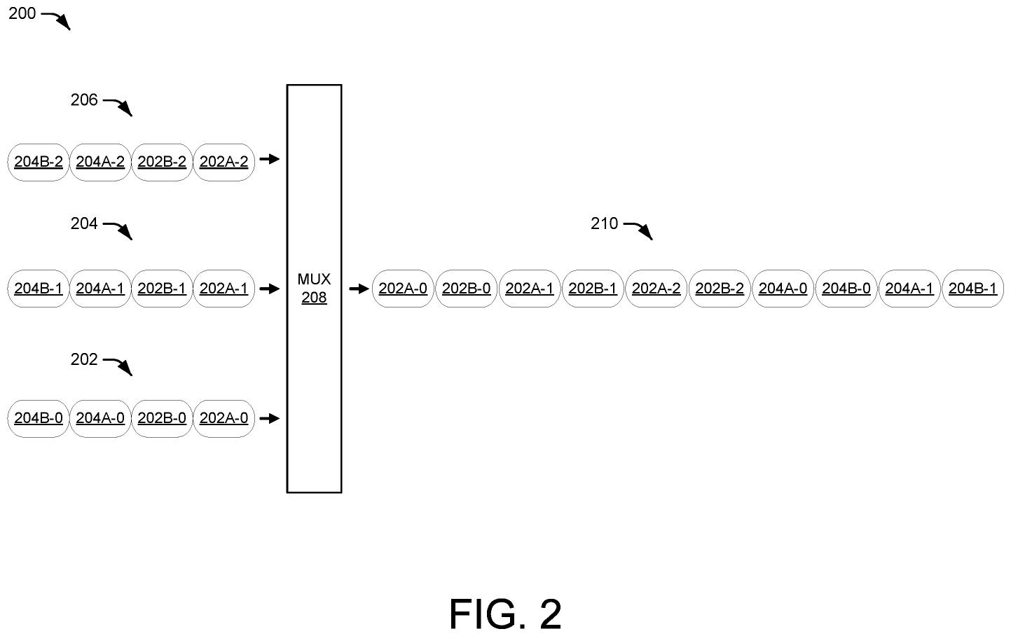

FIG. 2 illustrates an example 200 of symbol-pair multiplexing, according to an example. The example 200 includes data lanes 202-206, a symbol-pair multiplexer 208, and a physical link 210. In various embodiments, the example 200 is included in the transmitter of the communications system. Data lane 202 is illustrated to include a first pair of symbols 202A-0, 202B-0 and a second pair of symbols 204A-0, 204B-0; data lane 204 includes a first pair of symbols 202A-1, 202B-1 and a second pair of symbols 204A-1, 204B-1; and data lane 206 includes a first pair of symbols 202A-2, 202B-2 and a second pair of symbols 204A-2, 204B-2.

In some examples, the symbol-pair multiplexer 208 utilizes a round-robin multiplexing technique which outputs one pair of symbols from each of the data lanes 202-206 (e.g., the 25 Gbps data lanes) and then repeats the multiplexing technique in order to generate a data stream for transmission over the physical link 210 (e.g., the single 200 Gbps physical link). As shown, the data stream includes the symbol-pair 202A-0, 202B-0 followed by the symbol-pair 202A-1, 202B-1 which is followed by the symbol-pair 202A-2, 202B-2. For instance, the symbol-pair 202A-2, 202B-2 is followed by the symbol-pair 204A-0, 204B-0 which is followed by the symbol-pair 204A-1, 204B-1, and so forth.

FIGS. 3A, 3B, and 3C illustrate an example of a timing misalignment relative to a physical interface, according to an example. FIG. 3A illustrates a representation 300 of even and odd data lanes based on the IEEE 802.3dj standard before transmission via the physical link 210. FIG. 3B illustrates a representation 302 of multiplexed symbol-pairs with 10 bits of skew. FIG. 3C illustrates a representation 304 of the even and odd data lanes recovered with incorrect de-multiplexing based on the 10 bits of skew.

With reference to FIG. 3A, the representation 300 is illustrated to include data lanes 306-320. For example, data lane 306 is an even numbered data lane and includes symbol-pair 302A-0, 302B-0; symbol-pair 304A-0, 304B-0; and symbol-pair 306A-0, 306B-0. The data lane 306 does not include an offset because the data lane 306 is an even numbered data lane. Data lane 308 is an odd numbered data lane and includes offset 322; symbol-pair 302A-1, 302B-1; symbol-pair 304A-1, 304B-1; and symbol 306A-1. In one example, offset 322 is a length equal to a length of a symbol (e.g., 10 bits).

As shown, data lane 310 is an even numbered data lane and includes symbol-pair 302A-2, 302B-2; symbol-pair 304A-2, 304B-2; and symbol-pair 306A-2, 306B-2. For instance, data lane 312 is an odd numbered data lane and includes offset 322; symbol-pair 302A-3, 302B-3; symbol-pair 304A-3, 304B-3; and symbol 306A-3. Data lane 314 is an even numbered data lane and includes symbol-pair 302A-4, 302B-4; symbol-pair 304A-4, 304B-4; and symbol-pair 306A-4, 306B-4. Data lane 316 is another odd numbered data lane and includes offset 322; symbol-pair 302A-5, 302B-5; symbol-pair 304A-5, 304B-5; and symbol 306A-5. For example, data lane 318 is an even numbered data lane. The data lane 318 includes symbol-pair 302A-6, 302B-6; symbol-pair 304A-6, 304B-6; and symbol-pair 306A-6, 306B-6. Finally, data lane 320 is an odd numbered data lane which includes offset 322; symbol-pair 302A-7, 302B-7; symbol-pair 304A-7, 304B-7; and symbol 306A-7.

As illustrated in FIG. 3B, the representation 302 includes a data stream 326. In various embodiments, the symbol-pair multiplexer 208 generates the data stream 326 by multiplexing the data lanes 306-320. The data stream 326 is illustrated to include skew 324. For example, the skew 324 is due to SERDES starting to sample 10 bits before a start of the symbol-pair 302A-0, 302B-0 which is the first symbol-pair in the data lane 306. Notably, the data lane 306 is a first data lane of the data lanes 306-320.

For instance, offset 322 follows the symbol-pair 302A-0, 302B-0 in the data stream 326, and the symbol 302A-1 follows offset 322 in the data stream 326. In one example, offset 322 and the symbol 302A-1 collectively occupy the first 20 bits of the data lane 308. The symbol-pair 302A-2, 302B-2 follows the symbol 302A-1 in the data stream 326. In an example, this is because the symbol-pair 302A-2, 302B-2 is the first symbol-pair in the data lane 310. For example, offset 322 follows the symbol-pair 302A-2, 302B-2 in the data stream 326, and the symbol 302A-3 follows offset 322 in the data stream 326 because offset 322 and the symbol 302A-3 collectively occupy the first 20 bits of the data lane 312.

With reference to FIG. 3C, the representation 304 includes recovered data lanes 328-342 that do not match corresponding ones of the data lanes 306-320 because of the skew 324. For instance, recovered data lane 328 includes the skew 324 followed by the symbol 302A-0 which is followed by the symbol 302A-7. The recovered data lane 328 should not include the skew 324 and the recovered data lane 328 also should not include the symbol 302A-7 which was included in the data lane 320. The symbol 304A-0 follows the symbol 302A-7, and the symbol 304A-7 follows the symbol 304A-0 in the recovered data lane 328. Finally, the recovered data lane 328 includes the symbol 306A-0 after the symbol 304A-7 and the symbol 306A-7 after the symbol 306A-0.

As illustrated in FIG. 3C, each of the recovered data lanes 330-342 includes incorrect symbols based on the skew 324. In various embodiments, in order to avoid the incorrect de-multiplexing based on the skew 324, 20 independent de-multiplexing operations can be performed, with a result of each operation checked for an alignment marker. In these embodiments, a de-multiplexing operation of the 20 independent operations which assumes the skew of 10 bits (e.g., the skew 324) will correctly de-multiplex the physical link 210 and the alignment marker is detectable by checking a result of the de-multiplexing operation. For example, once the alignment marker is detected, then the assumption of the skew of 10 bits is confirmed, and the skew 324 can be corrected such that the recovered data lanes 328-342 match corresponding ones of the data lanes 306-320.

FIG. 4 illustrates receiver circuitry 400, according to an example. The receiver circuitry 400 is illustrated to include first shifter circuitry 402, the correlator circuitry 100, second shifter circuitry 404, and alignment marker capture circuitry 406. In an example, the first shifter circuitry 402 is a first phase of multiple phases of shifting included in alignment detection circuitry. In this example, the first phase of shifting occurs before all data lanes are locked (e.g., while the correlator circuits 104, 106 are searching for bits matching the bits of the reference alignment marker and before a candidate data lane being searched is locked). For example, the first shifter circuitry 402 receives the skew information from the shift selection circuit 108 via the matching output 126, the partially matching output 128, and/or the shift output 130.

In various embodiments, the second shifter circuitry 404 includes a second phase of shifting of the multiple phases that includes multiple stages which occur after all data lanes are locked. For instance, a first stage of the multiple stages is configured to remove the bit skew (e.g., 0 to 19 bits, 0 to 39 bits, etc.) from the candidate data lanes after the candidate data lanes are locked. In an example, the first stage includes bit slip functionality within the SERDES. In another example, the first stage of the second shifter circuitry 404 includes a bit shifter block at an output of the SERDES.

In some embodiments, a second stage of the second shifter circuitry 404 is configured to remove lane skew from the output 112. For example, the lane skew is a multiple of 20 if the output 112 includes multiplexed symbol-pairs and the lane skew is a multiple of 40 if the output 112 includes multiplexed symbol-quartets. In this example, the lane skew may be relatively large (e.g., thousands of bits), and the second stage of the second shifter circuitry 404 is implemented using a deep buffer at the output of the first stage.

In one or more embodiments, a third stage of the second shifter circuitry 404 is configured to remove the 10 bit offset (e.g., offset 322) from the odd numbered data lanes. For example, the third stage is configured to align the even numbered data lanes and the odd numbered data lanes. In some examples, the third stage of the second shifter circuitry accomplishes this alignment by delaying the even numbered lanes which effectively removes the 10 bit offset from the odd numbered data lanes.

In various embodiments, the alignment marker capture circuitry 406 is configured to capture alignment markers detected in the output 112. In some examples in which the correlator circuits 104, 106 are partial correlators, the alignment marker capture circuitry 406 includes a full correlator circuit, for example, to match all 12 nibbles of the reference alignment marker with nibbles of a candidate data lane included in the output 112. In one or more examples, the alignment marker capture circuitry 406 is capable of capturing common alignment markers which may indicate a location of a data lane within the output 112 and also capable of capturing unique alignment markers which can indicate whether a number of the data lane is even or odd.

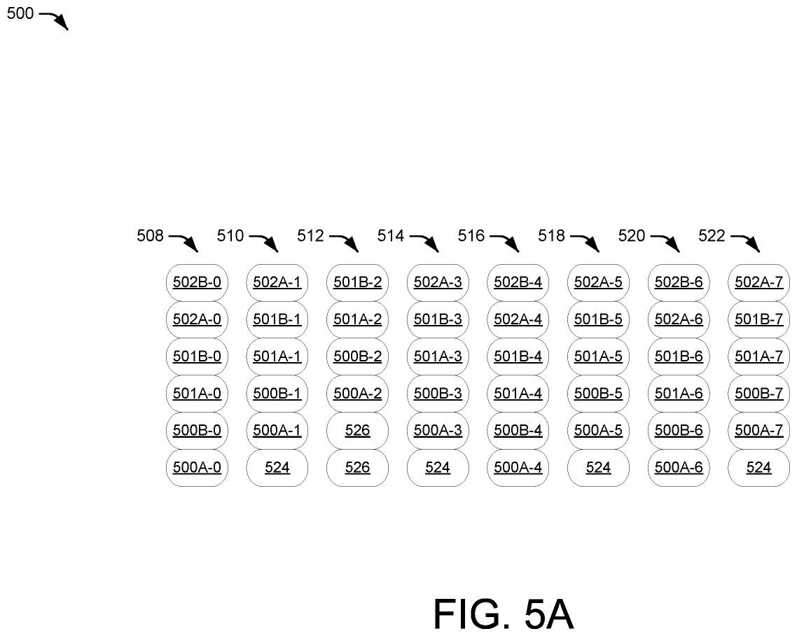

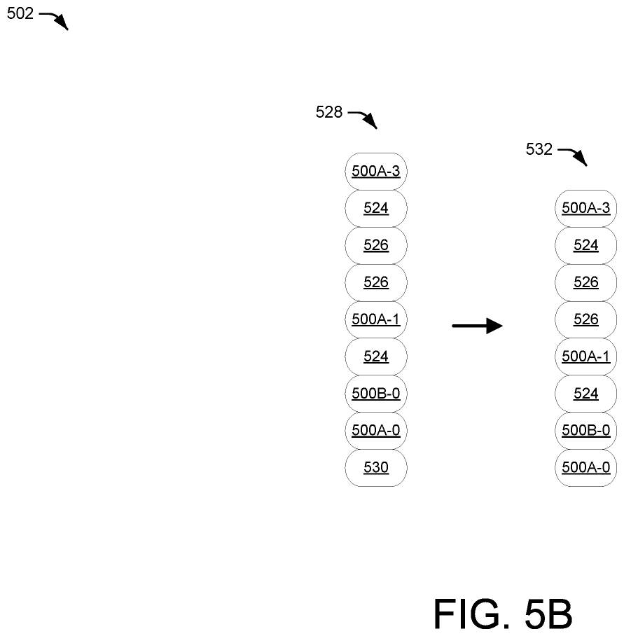

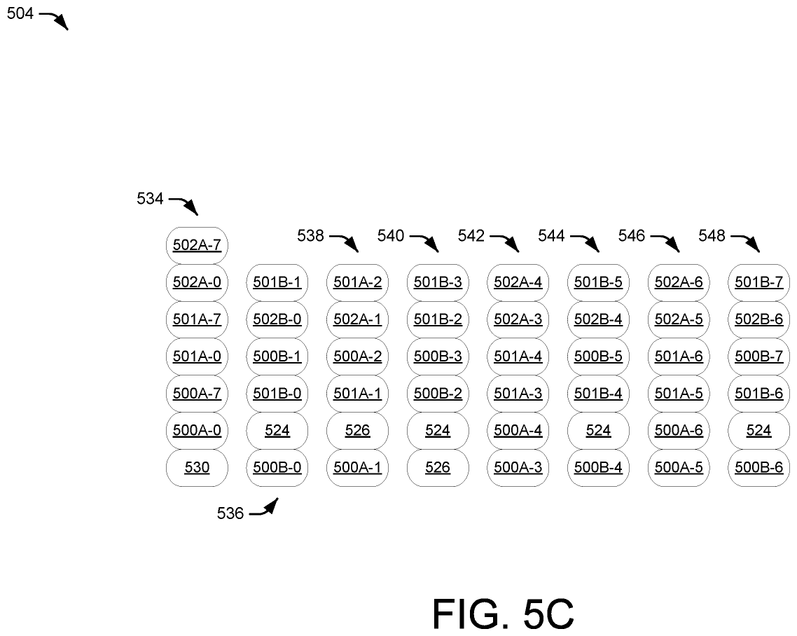

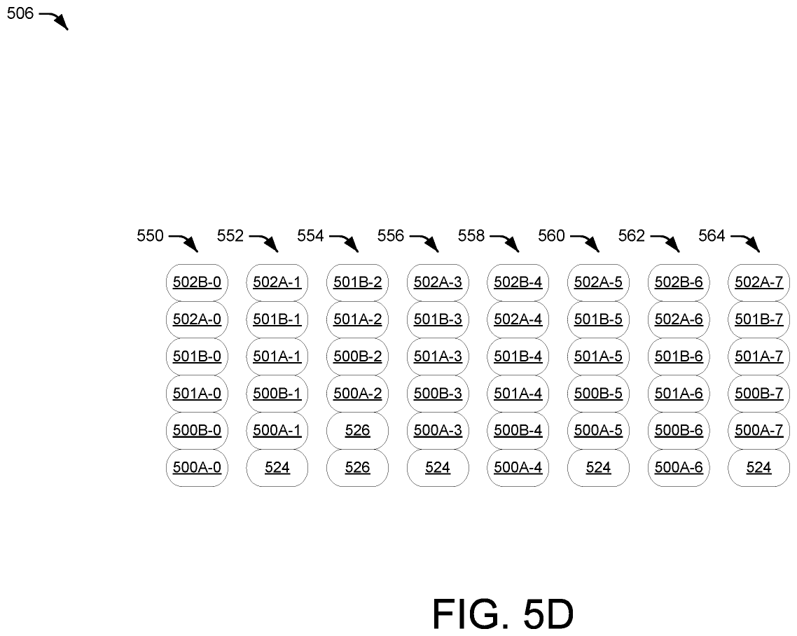

FIGS. 5A, 5B, 5C, and 5D illustrate an example of a timing misalignment relative to a physical interface and a timing misalignment relative to a data lane, according to an example. FIG. 5A illustrates a representation 500 of even and odd data lanes based on the IEEE 802.3dj standard before transmission via the physical link 210. FIG. 5B illustrates a representation 502 of multiplexed symbol-pairs with 10 bits of skew and without the 10 bits of skew. FIG. 5C illustrates a representation 504 of the even and odd data lanes recovered with incorrect de-multiplexing based on the 10 bits of skew. FIG. 5D illustrates a representation 506 of the even and odd data lanes recovered with correct de-multiplexing without the 10 bits of skew.

As shown in FIG. 5A, the representation 500 includes data lanes 508-522 having multiplexed symbol-pairs. For instance, data lanes 508, 512, 516, 520 are even numbered data lanes and do not include an offset. Data lanes 510, 514, 518, 522 are odd numbered data lanes and include offset 524 which is 10 bits. For example, data lane 512 includes skew 526 and skew 526 which are each 10 bits. Accordingly, in this example, data lane 512 includes a timing misalignment of 20 bits relative to the data lanes 508, 516, 520.

As illustrated in FIG. 5B, the representation 502 includes a data stream 528. In some embodiments, the symbol-pair multiplexer 208 generates the data stream 528 by multiplexing the data lanes 508-522. The data stream 528 is illustrated to include skew 530. In an example, the skew 530 is a result of SERDES starting to sample 10 bits before a start of symbol-pair 500A-0, 500B-0 which is the first symbol-pair in the data lane 508. The representation 502 also includes a data stream 532 which is the data stream 528 with the skew 530 removed. In one or more embodiments, the second shifter circuitry 404 is configured to remove the skew 530 (e.g., at the first stage).

With reference to FIG. 5C, the representation 504 includes recovered data lanes 534-548 that do not match corresponding ones of the data lanes 508-522 as a result of the skew 530. For instance, each of the recovered data lanes 534-548 includes an incorrect symbol. As shown in FIG. 5D, the representation 506 includes recovered data lanes 550-564 that match corresponding ones of the data lanes 508-522 because the skew 530 is removed. In some embodiments, the second shifter circuitry 404 is configured to remove the skew 530 (e.g., at the second stage).

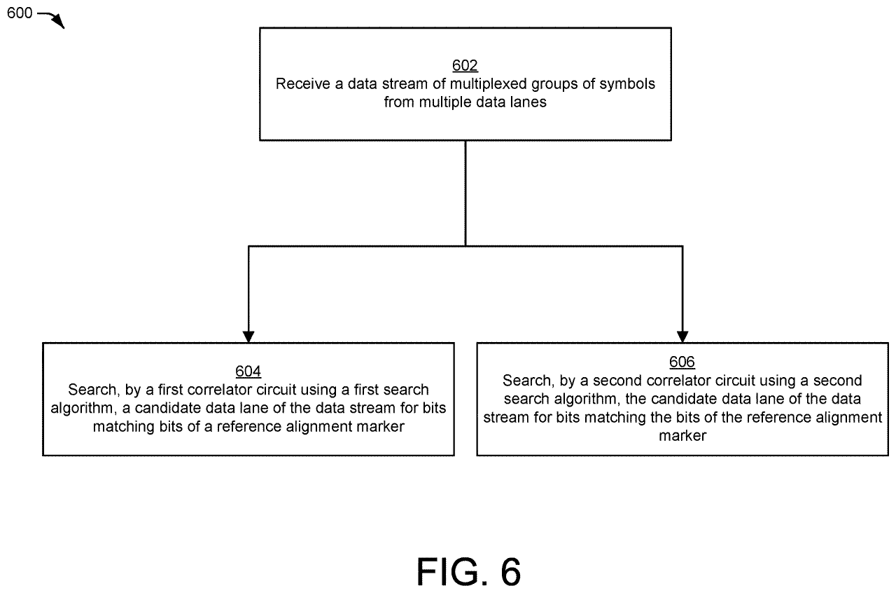

FIG. 6 is a flow diagram depicting a method 600 for alignment marker detection. At 602, a data stream of multiplexed groups of symbols from multiple data lanes is received. For example, the output 112 is received at the correlator circuits 104, 106. In one example, the groups of symbols include symbol-pairs. In another example, the groups of symbols include symbol-quartets.

At 604, a candidate data lane of the data stream is searched by a first correlator circuit using a first search algorithm for bits matching bits of a reference alignment marker. In various embodiments, the correlator circuit 104 searches a candidate data lane of the output 112 assuming that the candidate data lane is an even numbered data lane. For example, the correlator circuit 104 searches the candidate data lane of the output 112 assuming that the candidate data lane does not include a 10 bit offset.

At 606, the candidate data lane of the data stream is searched by a second correlator circuit using a second search algorithm for bits matching the bits of the reference alignment marker. In some embodiments, the correlator circuit 106 searches the candidate data lane of the output 112 assuming that the candidate data lane is an odd numbered data lane. In an example, the correlator circuit 106 searches the candidate data lane of the output 112 assuming that the candidate data lane includes a 10 bit offset.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

While the foregoing is directed to specific examples, other and further examples may be devised without departing from the basic scope thereof, and the scope thereof is determined by the claims that follow.

What is claimed is:

1. Alignment detection circuitry comprising:
a buffer configured to output a data stream of multiplexed groups of symbols from multiple data lanes;
a first set of correlators configured to search a candidate data lane of the data stream for bits matching bits of a reference alignment marker based on a first search method; and
a second set of correlators configured to search the candidate data lane of the data stream for bits matching the bits of the reference alignment marker based on a second search method.

2. The alignment detection circuitry of claim 1, wherein the first search method does not include an offset and the second search method includes the offset.

3. The alignment detection circuitry of claim 2, wherein the offset is a number of bits included in a symbol.

4. The alignment detection circuitry of claim 1, wherein the first set of correlators searches the candidate data lane of the data stream for bits matching a subset of the bits of the reference alignment marker.

5. The alignment detection circuitry of claim 4, wherein the first set of correlators is configured to output at least one of a complete match of the subset or a partial match of the subset.

6. The alignment detection circuitry of claim 1, further comprising first shifter circuitry of a first phase of shifting configured to add bit skew to the candidate data lane before the candidate data lane is locked.

7. The alignment detection circuitry of claim 6, further comprising second shifter circuitry of a second phase of shifting configured to remove the bit skew from the candidate data lane after the candidate data lane is locked.

8. The alignment detection circuitry of claim 7, wherein the second shifter circuitry of the second phase of shifting is further configured to remove lane skew from the data stream after the candidate data lane is locked.

9. The alignment detection circuitry of claim 8, wherein the second shifter circuitry of the second phase of shifting is further configured to remove an offset from the candidate data lane after the candidate data lane is locked.

10. Receiver circuitry comprising:
a first correlator circuit configured to search a candidate data lane of a data stream of multiplexed symbols for bits matching bits of a reference alignment marker based on a first search method;
a second correlator circuit configured to search the candidate data lane of the data stream of the multiplexed symbols for bits matching the bits of the reference alignment marker based on a second search method; and
a selection circuit configured to select an output from at least one of the first correlator circuit or the second correlator circuit.

11. The receiver circuitry of claim 10, wherein the first correlator circuit searches the candidate data lane of the data stream for bits matching a subset of the bits of the reference alignment marker.

12. The receiver circuitry of claim 10, further comprising a buffer configured to output the data stream of the multiplexed symbols to the first correlator circuit and the second correlator circuit.

13. The receiver circuitry of claim 10, further comprising first shifter circuitry configured to add bit skew to the candidate data lane in a first phase of shifting before the candidate data lane is locked.

14. The receiver circuitry of claim 13, further comprising second shifter circuitry configured to remove the bit skew from the candidate data lane in a second phase of shifting after the candidate data lane is locked.

15. The receiver circuitry of claim 10, wherein the first search method does not include an offset and the second search method includes the offset.

16. A method comprising:
receiving a data stream of multiplexed groups of symbols from multiple data lanes;
searching, by a first correlator circuit using a first search algorithm, a candidate data lane of the data stream for bits matching bits of a reference alignment marker; and
searching, by a second correlator circuit using a second search algorithm, the candidate data lane of the data stream for bits matching the bits of the reference alignment marker.

17. The method of claim 16, wherein the first search algorithm does not utilize an offset and the second search algorithm utilizes the offset.

18. The method of claim 16, further comprising adding bit skew to the candidate data lane in a first phase of shifting before the candidate data lane is locked.

19. The method of claim 18, further comprising removing lane skew from the candidate data lane in a second phase of shifting after the candidate data lane is locked.

20. The method of claim 18, further comprising removing the bit skew from the candidate data lane in a second phase of shifting after the candidate data lane is locked.
